(19) United States
(12) Patent Application Publication
(10) Pub. No.: US 2026/0205194 A1
(43) Pub. Date: Jul. 16, 2026

(54) Raman Gain Measurements in Dynamically Controlled Optical Line Systems

(71) Applicant: Ciena Corporation, Hanover, MD (US)

(72) Inventor: Choudhury A. Al Sayeed, Stittsville (CA)

(73) Assignee: Ciena Corporation, Hanover, MD (US)

(21) Appl. No.: 19/018,076

(22) Filed: Jan. 13, 2025

(51) Int. Cl. H04B 10/079; H01S 3/00; H01S 3/067; H01S 3/094; H01S 3/30

(52) U.S. Cl. CPC H04B 10/07955; H01S 3/0014; H01S 3/06716; H01S 3/094011; H01S 3/094046; H01S 3/302; H04B 10/0793

(57) ABSTRACT

Systems and methods for measuring Raman gain in an optical span include, subsequent to determining a baseline measurement of a first total-power output at an upstream node and a first total-power input at a downstream node, causing a measurement a second total-power output at the upstream node and a second total-power input at the downstream node with one or more Raman pump lasers on; and determining a Raman gain for the optical span by comparing (a) a difference between the first total-power output and the first total-power input to (b) a difference between the second total-power output and the second total-power input. The baseline measurement was determined when one or more Raman pump lasers associated with the optical span were turned off. The Raman gain reflects an effective gain achieved over all of the optical span rather than only at a local amplifier input.

### FIELD OF THE DISCLOSURE

The present disclosure relates generally to optical networking. More particularly, the present disclosure relates to systems and methods for Raman gain measurements in dynamically controlled optical line systems.

### BACKGROUND OF THE DISCLOSURE

Raman amplification is a technique used in optical networks to extend the reach and capacity of signal transmission by taking advantage of stimulated Raman scattering in the optical fiber. In this process, high-power pump lasers inject energy into the fiber, either co-propagating, counter-propagating, or both with the signal wavelengths, causing part of that energy to transfer from the pump wavelength to the signal wavelengths. This distributed form of amplification reduces noise buildup and provides a flatter gain profile across multiple wavelengths, making it particularly beneficial in dense wavelength division multiplexing (DWDM) networks. However, because Raman amplification efficiency can vary with factors such as fiber composition, pump power, and signal wavelength, accurately measuring the Raman gain is crucial. Monitoring and controlling the Raman gain allows network operators to fine-tune pump power levels and optimize system performance, ensuring proper signal quality, reducing unwanted crosstalk, and maintaining reliable, high-capacity optical links in optical networks.

### BRIEF SUMMARY OF THE DISCLOSURE

The present disclosure relates to systems and methods for Raman gain measurements in dynamically controlled optical line systems. The present disclosure focuses on methods for accurately measuring Raman gain in a dynamically controlled optical line system. Traditional Raman gain measurement techniques generally assume a static control environment, where the Raman target gain remains constant, or the launch powers and spectral loading for a given span remain uninterrupted. However, these assumptions no longer hold in modern dynamically controlled optical line systems, where (1) the spectral loading can change (e.g., adding or removing channels in real time), (2) the total launch power can vary as different channels or power levels come online or go offline, and (3) the target gain of the Raman amplifier can be adjusted in-service to optimize the overall link budget. In such an environment, existing Raman gain evaluation methods can become error-prone, introducing “silent” errors that can propagate through multiple layers of the control and management system. These errors not only degrade the accuracy of the measured Raman gain itself, but they can also lead to suboptimal power settings, potential signal quality issues, and inefficient capacity usage.

The disclosure herein teaches that in order to reliably determine the actual Raman gain in a given span, it is crucial to consider both the span attributes and real-time conditions at the two nodes associated with the Raman span. By correlating data and measurements from both ends of the span—and factoring in dynamic changes in spectral loading, total launch power, and target gain—operators can accurately compute the Raman gain that is truly achieved in-service. This dynamic approach ensures proper link budget optimization, minimizes error propagation in the line system, and maintains stable network operations even under rapidly changing traffic patterns and power control strategies.

In various embodiment, the present disclosure contemplates implementation as a method with steps, via an apparatus configured to implement the steps where the apparatus is associated with an optical span or optical line systems, and as a non-transitory computer-readable medium storing instructions that, when executed, cause one or more processors or other circuitry to implement the steps. In an embodiment, the steps include, subsequent to determining a baseline measurement of a first total-power output at an upstream node and a first total-power input at a downstream node, measuring a second total-power output at the upstream node and a second total-power input at the downstream node with one or more Raman pump lasers on; and determining a measured Raman gain for the optical span by comparing (a) a difference between the first total-power output and the first total-power input to (b) a difference between the second total-power output and the second total-power input. The baseline measurement was determined when one or more Raman pump lasers associated with the optical span were turned off. The measured Raman gain reflects an effective gain achieved over all of the optical span rather than only at a local amplifier input.

The steps can further include updating the measured Raman gain in-service whenever at least one of a target Raman gain is adjusted, a spectral loading changes, or a total launch power varies in the upstream node. The target Raman gain can be automatically re-optimized by a control system in response to measured fiber losses or channel loading changes, and the step of updating the measured Raman gain occurs in near real-time without requiring an external manual recalibration request. The Raman pump lasers can operate in a counter-propagation mode, a co-propagation mode, or a hybrid bidirectional mode, and wherein the step of determining the measured Raman gain is performed in a manner agnostic to propagation direction. A baseline span loss can be determined by subtracting the first total-power output from the first total-power input in dB, and an updated span loss can be determined by subtracting the second total-power output from the second total-power input in dB, the measured Raman gain being the difference between the two span losses.

The steps can further include detecting and compensating for Raman gain compression, decompression, or suppression in the optical span by recalculating the measured Raman gain each time a significant reduction or increase in total launch power is detected at the upstream node. The steps can further include coordinating the measured Raman gain with an erbium-doped fiber amplifier (EDFA) upstream or downstream of the optical span, such that changes in EDFA output power trigger corresponding updates in the step of computing the Raman gain to maintain accurate span loss calculations. Both the upstream node and the downstream node: a) store the baseline measurement locally when the one or more Raman pump lasers are turned off; and b) exchange the stored baseline measurement once optical supervisory channel (OSC) communication is re-established, thereby synchronizing baseline data used to determine the measured Raman gain.

In another embodiment, the steps include obtaining a baseline measurement of total power under a first set of conditions; obtaining an updated measurement of total power under a second set of conditions in which one or more Raman pumps are activated, the total power under each of the first and second set of conditions is associated with an optical span; and determining a measured Raman gain based on the updated measurement and the baseline measurement.

### BRIEF DESCRIPTION OF THE DRAWINGS

The present disclosure is detailed through various drawings, where like components or steps are indicated by identical reference numbers for clarity and consistency.

FIG. 1 illustrates an example optical span formed by an optical line system in an optical network to demonstrate Raman amplification and the measurement of Raman gain.

FIG. 2 illustrates an example optical span incorporating a telemetry signal within a card located at an upstream node.

FIG. 3 illustrates a flowchart of a Raman gain measurement method.

FIG. 4 illustrates a graph of Raman gain compression effect in a span.

FIG. 5 illustrates a flowchart of another Raman gain measurement method.

FIG. 6 illustrates a flowchart of yet another Raman gain measurement method.

### DETAILED DESCRIPTION OF THE DISCLOSURE

Again, the present disclosure relates to systems and methods for Raman gain measurements in dynamically controlled optical line systems. FIG. 1 illustrates an example optical span 10 formed by an optical line system in an optical network to demonstrate Raman amplification and the measurement of Raman gain. In an optical network, the optical span 10 refers to the fiber link between two adjacent nodes (or sites). This span typically includes not just a physical fiber 12 but may also incorporate associated equipment such as optical amplifiers 14, 16, 18—e.g., erbium-doped fiber amplifiers (EDFAs) 14, 16, a Raman amplifier 18—as well as other in-line components (not shown) necessary for maintaining signal quality. As a fundamental building block of the optical network, the span 10 is designed to support a specific distance and bandwidth requirement while preserving adequate optical signal-to-noise ratio (OSNR). To achieve this, network designers carefully select the type of fiber (e.g., single-mode, dispersion-shifted) and place amplifiers at strategic intervals to compensate for optical losses incurred during signal propagation.

### Optical Line System

The optical span 20 is part of the broader optical line system, which is an integrated collection of optical components and subsystems responsible for carrying signals from one node to another—ultimately from a transmitter to a receiver—across one or more spans 20. In dense wavelength-division multiplexing (DWDM) networks, the optical line system typically includes wavelength multiplexers/demultiplexers, reconfigurable optical add-drop multiplexers (ROADMs), various amplifiers, and other modules such as dispersion compensators or optical channel monitors. All of these elements work in concert to route, switch, amplify, and manage optical signals, ensuring they meet strict performance and reliability requirements over long distances. Although FIG. 1 omits many of these elements for simplicity, it illustrates a single optical span 10 including the fiber 12 and amplifiers 14, 16, 18.

In practice, one or more EDFAs 14, 16 may be located near the transmitter and receiver nodes, or even in mid-span, to maintain adequate signal power. The Raman amplifier 18 provides additional, distributed amplification along the fiber 12 itself by injecting high-power pump wavelengths that transfer energy to the signal wavelengths through stimulated Raman scattering. Depending on the network design, Raman pumping can occur in the same direction as the signal (co-propagation), in the opposite direction (counter-propagation), or both. This approach helps to reduce noise accumulation, flatten gain across multiple channels, and extend the reach of high-capacity DWDM systems. For illustrative purposes, FIG. 1 focuses on a single optical span 10, demonstrating how Raman amplification is achieved in-line and how the corresponding Raman gain can be measured under various operating conditions. Of course, a practical optical network includes multiple optical spans 10, such as in a mesh configuration, connecting various ROADMs to one another. The approach described herein for Raman gain measurement can be implemented for each span 10.

In a typical optical line system, the EDFAs 14, 16 and the Raman amplifier 18 can be modules or cards. The EDFAs 14, 16 include a coil of fiber doped with erbium ions, which provide the amplification medium for signals. The card includes one or more pump laser diodes—often operating at wavelengths around 980 nm or 1480 nm—that inject energy into the erbium-doped fiber. As the optical signal passes through this energized fiber, the erbium ions transfer their energy to the signal, thereby boosting its power. In addition to the pump diodes, the EDFA card contains various optical components such as couplers, isolators, and filters to ensure stable and efficient amplification while preventing unwanted back reflections and spurious noise. On the electronics side, there are control circuits to regulate pump current and temperature, along with power monitoring photodiodes to measure input and output levels in real time. These monitoring and control elements enable the EDFA to maintain a set gain profile, protect the network from power surges, and preserve signal quality.

The Raman amplifier 18 card includes high-power pump lasers 20 that provide distributed amplification via stimulated Raman scattering directly within the transmission fiber 12. Instead of using a short, doped fiber for amplification (as in an EDFA), Raman amplification is achieved over the length of the transmission fiber 12 itself: when the pump laser wavelengths (often in the 1400-1500 nm range) co-propagate or counter-propagate with the signal, they transfer energy to the signal channels. The Raman amplifier 18 card therefore houses multiple pump lasers 20 at carefully selected wavelengths to create a broad gain spectrum for DWDM applications. It also includes optical coupling components, isolators, and built-in safety measures to handle the potentially high pump power involved. An onboard control system monitors the pump lasers' output, temperature, and stability, coordinating with the rest of the line system to maintain optimal gain and minimize impairments such as noise or fiber nonlinearities. The Raman amplifier 18 card also includes power monitoring photodiodes, PDi, PDo, at the input and output of the Raman amplifier 18 card.

### Raman Gain Measurement

The following describes the current Raman gain measurement approach in the optical span:

Baseline Measurement with Pumps OFF: The Raman amplifier 18 card determines a reference (or baseline) value for the total input power by measuring a signal when all Raman pumps are turned OFF. This baseline represents the total optical power entering the Raman amplifier 18 card without any contribution from the Raman pump lasers 20. Because the fiber's loss and any other system components are unaltered in this baseline measurement, the baseline ideally captures all non-Raman sources of power in the span.

Gain Calculation with Pumps ON: Once the pump lasers 20 are turned ON, the Raman amplifier 18 card measures the new total power at its input, PDi. The difference between this new power measurement and the stored baseline is taken to represent the measured Raman gain. This simple subtractive approach assumes that any increase in total input power, relative to the baseline, directly corresponds to the additional power provided by Raman pumping.

Static Baseline Assumption: After this initial baseline is captured, the system does not re-evaluate the baseline total power until the pump lasers 20 are toggled OFF again. In other words, if the Raman pump lasers 20 remain ON, the baseline remains fixed-even if upstream conditions (like total launch power or channel loading) change over time.

The measured Raman gain is recalculated only under the following conditions:
(1) Pump States Are Toggled (OFF→ON, or ON→OFF): A new baseline measurement is taken when the pump lasers 20 turn OFF, and then gain is recalculated when they turn ON.
(2) New Target Gain Provisioned: If an operator sets a new target Raman gain, the pump laser 20 powers change, and the card recalculates the Raman amplifier 18 card accordingly.

In-Service Operation Limitation: Under normal in-service network conditions—where the Raman pump lasers 20 are left ON and no new target gain is provisioned—the measured Raman gain remains frozen. Even if the launch power changes upstream (for instance, when channels are added or dropped, or EDFA settings change), the optical line system continues to rely on the same baseline. Consequently, any change in the real Raman gain due to dynamic traffic patterns or other adjustments is not captured in the reported measurement.

In a typical system design, the measured Raman gain is factored into calculating the actual physical fiber loss of a span 20:

Physical-fiber-loss in the optical span 20=total launch power into the optical span 20−total-received power at the end of the optical span 20+measured Raman gain

Because this formula depends directly on the accuracy of the measured Raman gain, any inaccuracy in that gain measurement flows into the reported fiber loss value. If launch power into the span changes—due to channel additions/removals or adjustments in upstream EDFAs 14—and the Raman target gain is subsequently changed, the unchanged baseline (taken with the pump lasers 20 OFF at an earlier time) will yield an incorrect measured Raman gain. This mismatch can lead to significant errors since the new total input power is no longer aligned with the old baseline.

Critical Problems Arising from Erroneous Measurements:
(1) Span Recalibration Errors: When the optical span 20 is recalibrated (which can be done in or out of service), nodes in the optical span 20 typically adjust their amplifiers sequentially. If the launch power has been re-adjusted by ±X dB from its previous setting, and then a new Raman target gain is set, the resulting measured Raman gain can be off by ±X dB. This propagates directly into the span fiber loss calculation, potentially triggering spurious “high fiber loss” or “low fiber loss” alarms. Once these errors occur, any subsequent recalibration attempts start from a faulty reference, causing the errors to compound over time.
(2) Instability in Dynamic Span Control: In dynamic line systems, the Raman target gain may be adjusted alongside EDFA target gains for real-time compensation of changing span losses. However, because the existing Raman gain measurement approach does not update the baseline unless the pumps are toggled OFF, the controller's feed-forward or automated optimization loops can become unstable. The system effectively works with stale measurement data, undermining the precise control necessary for high-performance, reconfigurable optical networks.

In summary, these current Raman gain measurement methods—reliant on a single baseline measurement and triggered recalculations—are too rigid for today's dynamically controlled and reconfigurable optical line systems. The inaccuracies introduced by this approach can negatively impact span loss calculations, automatic network optimization routines, and overall service reliability.

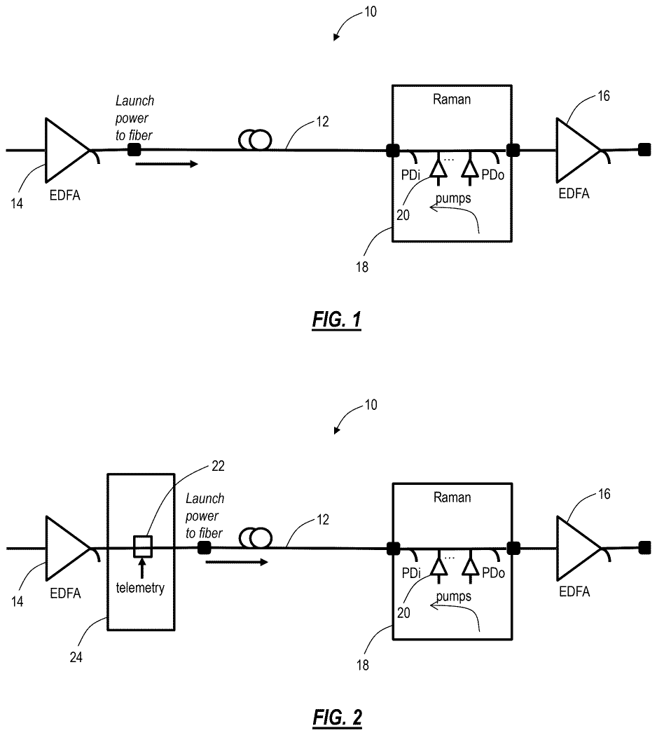

FIG. 2 illustrates an example optical span 10 incorporating a telemetry signal 22 within a card 24 located at an upstream node. The telemetry signal 22 is out-of-band, meaning it propagates at a wavelength separate from the main DWDM traffic (e.g., 1510 nm, 1625 nm, or similar, whereas DWDM traffic, in the C-band, is between about 1528 nm-1565 nm). In various embodiments, the telemetry signal 22 may include, without limitation, an optical service channel (OSC) used for network management, an optical time domain reflectometer (OTDR) signal for monitoring fiber characteristics, a dedicated Raman monitoring signal, or another suitable out-of-band wavelength. By placing this signal outside the traffic-carrying wavelengths, the system can measure certain performance metrics-such as Raman gain—without disrupting the main data channels.

In practice, Raman gain for the out-of-band telemetry channel is measured similarly to the total-power method described previously. First, a baseline is captured by measuring the telemetry receive (Rx) power when the Raman pumps are OFF. Then, once the pump lasers 20 are turned ON, the new Rx power for the telemetry signal 24 is measured. The difference between these two measurements is used to infer the Raman gain experienced by the telemetry channel. Because the telemetry transmit (Tx) power at the far end of the span is maintained at a constant level—regardless of fiber type, span length, traffic load, or other environmental variables—this approach theoretically allows the local node to isolate and measure the incremental gain provided by the Raman pumps.

However, depending on the exact wavelength of the telemetry signal 22, its measured gain can be significantly affected by stimulated Raman scattering (SRS) that arises from the main DWDM channels. As capacities on the line system are added or removed, the spectral loading changes, which alters the SRS distribution in the fiber. Since SRS causes energy to transfer between different wavelengths, these dynamic spectral changes can, in turn, vary the effective Raman gain for the out-of-band telemetry channel. Thus, while using an out-of-band telemetry signal offers clear advantages—such as avoiding interference with primary traffic for in-service measurements—it must still be monitored carefully to account for SRS-induced gain fluctuations. Operators often address these challenges through calibration procedures, continuous monitoring, and advanced control loops designed to dynamically adjust the measured telemetry-based Raman gain to reflect real-time conditions in the optical span.

Again, in practice, multiple issues have been observed in the field when relying on traditional Raman gain measurement methods, and most of these problems remain “silent” in the network—i.e., they do not generate obvious alarms or immediate performance degradations that prompt operator action. For example,
(a) inaccurate Raman gain estimations can lead to incorrect physical fiber loss calculations, causing suboptimal launch powers and, in some instances, false fiber loss alarms. This discrepancy can degrade overall network performance and reliability by either underdriving or overdriving subsequent amplifiers.
(b) Additionally, there can be a significant mismatch between Raman gain measured via telemetry signals and Raman gain inferred from total power measurements. It often proves difficult to ascertain whether this mismatch stems purely from stimulated Raman scattering (SRS)—as capacity is added or dropped—or from flawed Raman gain calculations, or a combination of both factors. These existing complications make it nearly impossible to perform in-service adjustments or optimization of Raman target gain, because any recalibration based on faulty measurements risks propagating and compounding errors throughout the network.

The issue of accurate Raman gain estimation is generic across various optical network architectures; hence, the new method described here is intended as a straightforward yet robust approach to eliminate these “silent” errors, ensuring more reliable fiber loss calculations and enabling dynamic, in-service Raman gain optimizations.

### Improved Raman Gain Measurement

Accordingly, the present disclosure includes a method for measuring Raman gain in an optical span that takes into account both the total launch power entering the span (i.e., the total-power output at an upstream node) and the total received power at the end of the span (i.e., the total-power input at a downstream node). This differs fundamentally from conventional methods, which typically focus on measuring received power only at the local Raman amplifier 18 card input. By considering how the overall span loss changes with and without Raman pumping, the method determines the effective Raman gain experienced over the entire fiber span itself. In essence, the baseline span loss is captured when the Raman pump lasers 20 are turned OFF—recording both the total-power output at the upstream node and the total-power input at the downstream node of the span 10—and is then compared to the new loss measured when the pump lasers 20 are turned ON. The difference in these two span loss measurements corresponds directly to the actual Raman gain imparted by the fiber 12 in that span 20. This approach enables in-service Raman gain evaluation under a wide range of conditions, including changes in spectral loading or upstream launch power fluctuations, and it allows the reported gain to be continuously updated without requiring manual toggling of pump lasers 20 or external recalibration triggers, i.e., can be performed in-service.

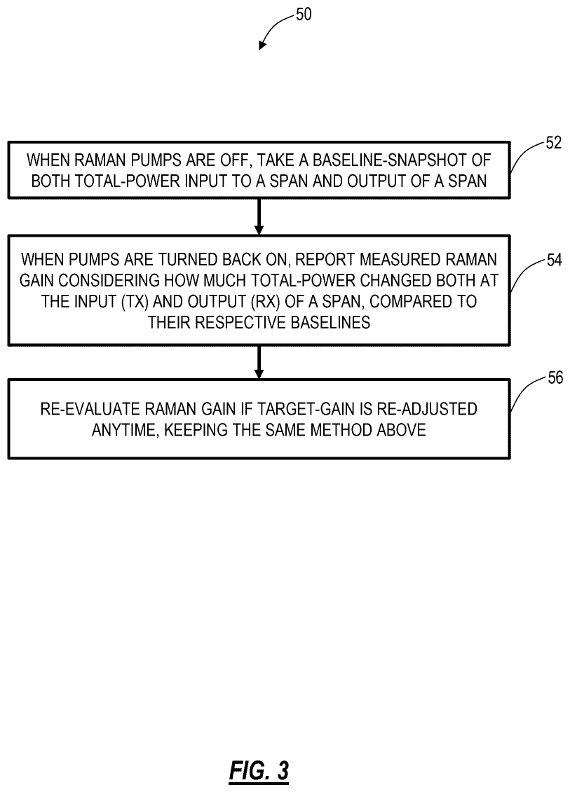

FIG. 3 is a flowchart of a Raman gain measurement method 50. Under this proposed method 50, the operational steps include: (1) when the Raman pumps are switched off, both the upstream node (transmit side) and the downstream node (receive side) record baseline snapshots of their total-power levels, effectively establishing the baseline span loss (step 52); (2) when the pumps are turned on again, each node measures the new total-power levels, and the resulting difference from the baseline is used to compute the achieved Raman gain (step 54); and (3) if, at any time, the target Raman gain is adjusted (e.g., to optimize link budgets), the same measurement process is repeated with new baselines (step 56). By re-evaluating in this manner, network operators can continuously maintain accurate Raman gain assessments even as the system undergoes dynamic changes.

In out-of-service calibration or recalibration scenarios—where toggling the pumps off temporarily disrupts OSC communication over a particularly long or “stretched” span—the total launch power at the upstream node can still be recorded locally. Although supervisory messages might not flow to the downstream node while the pumps are off, the upstream node can store the baseline launch power measurement and then share it once pump power is restored and supervisory communication is re-established. This ensures that both endpoints remain in sync regarding the baseline measurements. Additional filtering or smoothing of power samples from both nodes helps avoid transient errors that can arise from rapid or asynchronous sampling, ensuring that reported Raman gains reflect stable, real-time conditions.

Ultimately, this method 50 recognizes that Raman gain is a function of the entire span. Rather than focusing solely on changes in the received signal at the Raman amplifier 18 card input, the proposed approach coordinates data from both the upstream and downstream nodes to derive a more accurate measure of how much gain the fiber 12 itself is contributing. Moreover, while the detailed examples given here assume counter-propagating Raman pumping, the same principles apply equally well to co-propagating, bidirectional, or hybrid Raman configurations. By accurately tracking power deltas at both ends of the span 10, this method 50 effectively eliminates the “silent” errors that can arise from legacy measurements and enables more reliable in-service adjustments to meet the increasingly dynamic demands of modern optical networks.

The measured Raman gain can be expressed as follows:

$$MeasuredRamanGain ( in linear ) = ( \frac{{TotalPower}_{\frac{rx}{pumpsOn}}}{{BaselineTotalPower}_{\frac{rx}{pumpsOff}}} * \frac{{BaselineTotalPower}_{\frac{tx}{pumpsOff}}}{{TotalPower}_{\frac{tx}{pumpsOn}}} )$$

$$MeasuredRamanGain ( in dB ) = ( {TotalPower}_{rx / pumpsOn ( dBm )} - {BaselineTotalPower}_{rx / pumpsOff ( dBm )} ) - ( {TotalPower}_{tx / pumpsOn ( dBm )} - {BaselineTotalPower}_{tx / pumpsOff ( dBm )} )$$

### Raman Gain Compression or Suppression

Another phenomenon that leads to inaccurate Raman gain measurements is the dynamic compression or suppression of Raman gain within the optical span 20. When the launch power into the optical span 20 span suddenly drops, the reduced signal level triggers stronger Raman gain compression, effectively pushing more power to the receiving end. This phenomenon changes the measured power difference (delta) between the transmit and receive points, which can make it appear as though the span loss has decreased. Conversely, when the launch power significantly increases, the measured loss may appear higher, despite no real change in the physical fiber characteristics.

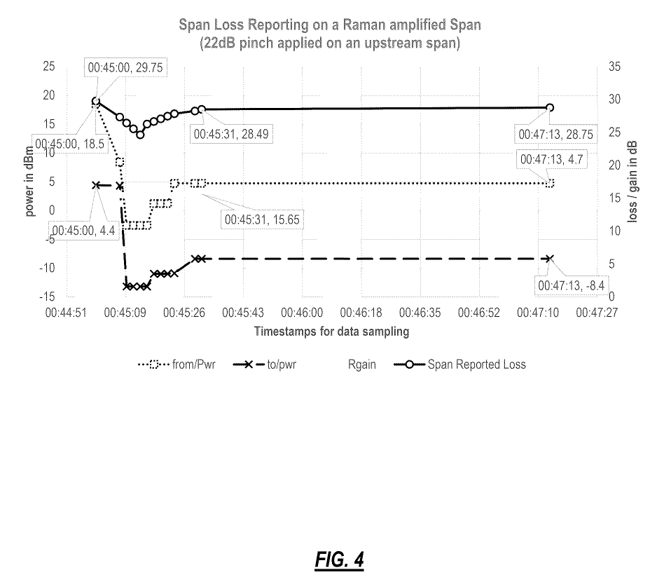

A laboratory test vividly demonstrated this behavior (FIG. 4 is a graph of this test): a 22 dB “pinch” was introduced (i.e., reduction) in launch power on an upstream span, which caused the reported physical span loss in the immediately downstream Raman-amplified span to drop by roughly 1 dB—from 29.75 dB to 28.75 dB over a period of about two minutes. During this time, both the transmit and receive power on that downstream span fell, then partially recovered, ultimately remaining 14 dB below the original level. Notably, the upstream controller compensated about 8 dB within those two minutes (7.5 dB in the first 30 seconds), showcasing how rapidly Raman gain compression can distort measured span loss. With the lower upstream power, the downstream span appeared to receive about 1 dB more power, thus increasing the apparent Raman gain; however, the reported Raman gain from the Raman card stayed fixed at 15.65 dB under the conventional method, which does not recalculate gain unless a manual recalibration or a new target gain request is issued from a management system.

Under the proposed measurement approach, these dynamic changes would be re-evaluated automatically, providing a more accurate reflection of real-time Raman gain. By way of example, the baseline span loss (with pumps off) is measured at 29.75 dB, and the initial power delta between transmit and receive is 14.1 dB (18.5 dB-4.4 dB). Subtracting the power delta from the baseline gives an initial Raman gain of 15.65 dB (29.75 dB-14.1 dB). After the 22 dB pinch and power drop, the new power delta is 13.1 dB=4.7 dB-(−8.4) dB, yielding a recalculated Raman gain of 16.65 dB (29.75 dB-13.1 dB). This real-time recalculation captures the effect of the upstream pinch and correctly reports the changing Raman gain-something legacy methods fail to do unless they go through another recalibration cycle.

### Raman Gain Measurement Method

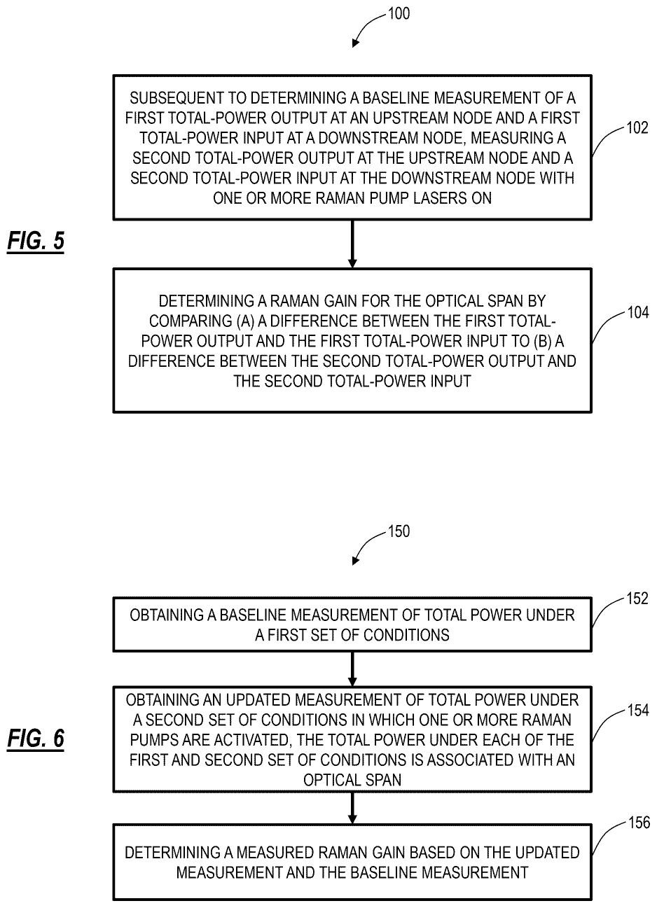

FIG. 5 illustrates a flowchart of a Raman gain measurement method 100. The Raman gain measurement method 100 contemplates implementation as a method with steps, via the optical line system and associated components and/or an apparatus that includes a processing device or circuitry configured to implement the steps, and as a non-transitory computer-readable medium storing instructions that, when executed, cause one or more processors to implement the steps.

The method 100 includes, subsequent to determining a baseline measurement of a first total-power output at an upstream node and a first total-power input at a downstream node, measuring a second total-power output at the upstream node and a second total-power input at the downstream node with one or more Raman pump lasers on (step 102); and determining a Raman gain for the optical span by comparing (a) a difference between the first total-power output and the first total-power input to (b) a difference between the second total-power output and the second total-power input (step 104). The baseline measurement was determined when one or more Raman pump lasers associated with the optical span were turned off. The Raman gain reflects an effective gain achieved over all of the optical span rather than only at a local amplifier input.

The method 100 can further include updating the measured Raman gain in-service whenever at least one of a target Raman gain is adjusted, a spectral loading changes, or a total launch power varies in the upstream node. The target Raman gain can be automatically re-optimized by a control system in response to measured fiber losses or channel loading changes, and the step of updating the measured Raman gain occurs in near real-time without requiring an external manual recalibration request. The Raman pump lasers can operate in a counter-propagation mode, a co-propagation mode, or a hybrid bidirectional mode, and wherein the step of computing the Raman gain is performed in a manner agnostic to propagation direction.

A baseline span loss is determined by subtracting the first total-power output from the first total-power input in dB, and an updated span loss is determined by subtracting the second total-power output from the second total-power input in dB, the measured Raman gain being the difference between the two span losses. The method 100 can further include detecting and compensating for Raman gain compression, decompression, or suppression in the optical span by recalculating the Raman gain each time a significant reduction or increase in total launch power is detected at the upstream node.

The method 100 can further include coordinating the Raman gain measurement with an erbium-doped fiber amplifier (EDFA) upstream or downstream of the optical span, such that changes in EDFA output power trigger corresponding updates in the Raman gain to maintain accurate span loss calculations. Both the upstream node and the downstream node: a) store the baseline measurement locally when the one or more Raman pump lasers are turned off; and b) exchange the stored baseline measurement once optical supervisory channel (OSC) communication is re-established, thereby synchronizing baseline data used to determine the Raman gain.

FIG. 6 illustrates a flowchart of another Raman gain measurement method 150. The Raman gain measurement method 150 contemplates implementation as a method with steps, via the optical line system and associated components and/or an apparatus that includes a processing device or circuitry configured to implement the steps, and as a non-transitory computer-readable medium storing instructions that, when executed, cause one or more processors to implement the steps.

The method 150 includes obtaining a baseline measurement of total power under a first set of conditions (step 152); obtaining an updated measurement of total power under a second set of conditions in which one or more Raman pumps are activated, the total power under each of the first and second set of conditions is associated with an optical span (step 154); and determining a measured Raman gain based on the updated measurement and the baseline measurement (step 156). Note, the total power includes more than just the power at the downstream node or upstream node, but reflects the total power input and output from the total span, thereby being dependent on conditions on the optical span. The conditions include spectral loading, power, and the like.

The baseline measurement is determined while the one or more Raman pumps associated with the optical span are deactivated. The measured Raman gain characterizes the overall gain across the optical span, without limiting the measurement to a specific localized amplifier input. Also, various other features described above with reference to the method 100 apply equally to the method 150.

These approaches of measuring Raman gain by considering both the total-power input at the downstream node and total-power output at the upstream node of an optical span-rather than focusing on only the local amplifier input—confers several significant benefits and advantages:
(1) Improved Accuracy Across the Entire Span: By basing the gain calculation on the difference in power between the upstream and downstream nodes, the method reflects the true fiber-level Raman gain over the entire span. Traditional approaches that measure only at a single amplifier input can overlook losses or gains that occur downstream, leading to skewed or incomplete results.
(2) Dynamic, In-Service Adaptability: Because the method periodically re-checks both the upstream launch power and the downstream received power, operators can continuously update Raman gain under real-time conditions, such as changes in traffic loading or spectral configurations. This in-service adaptability allows for prompt recalibration if the launch power changes, helping maintain optimal link performance at all times.
(3) Reduction of “Silent” Errors: Legacy measurement methods often assume a static baseline, which remains unchanged unless pumps are toggled off. This can introduce “silent” errors that do not immediately trigger alarms but degrade performance or cause misleading fiber loss calculations. By incorporating both nodes' data, the method identifies and corrects these inaccuracies, preserving the reliability of network metrics like span loss and OSNR.
(4) Greater Control System Stability: In modern, dynamically reconfigurable networks, Raman target gain may be adjusted in tandem with upstream EDFAs or channel power settings. Because this method captures both input and output power changes in real time, control loops can rely on accurate measurements, making it less likely that feed-forward or automated optimization routines will become unstable due to stale or inaccurate baseline data.
(5) Compatibility with Various Raman Configurations: Whether the Raman pump lasers are co-propagating, counter-propagating, or bidirectional, this technique works equally well by focusing on the net span loss difference. This ensures that operators can standardize their measurement procedures even in complex network environments
(6) Enhanced Flexibility for Long, “Stretched” Spans: During out-of-service or partial-service calibration, supervisory channels may be lost if pumps are turned off in a long span. Under this approach, each node can store its baseline measurements locally and later exchange them once communication is restored. This resiliency allows calibration or recalibration to proceed effectively even when stretches of fiber disrupt direct supervisory messaging.
(7) Better Detection of Raman Gain Compression Effects: The method reveals how gain compression or suppression dynamically affects the entire span. By comparing real-time power deltas with previously established baselines, operators can quickly identify and compensate for scenarios where the same Raman pump power produces different levels of gain due to changes in upstream conditions.

Overall, these advantages significantly improve the fidelity of Raman gain measurements, enhance the stability of network control systems, and reduce the risk of costly performance degradations or service-affecting errors. This enables operators to manage and optimize their optical networks with confidence, even in fast-changing, high-capacity DWDM environments.

### CONCLUSION

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A method for measuring Raman gain in an optical span, the method comprising steps of:
subsequent to determining a baseline measurement of a first total-power output at an upstream node and a first total-power input at a downstream node, measuring a second total-power output at the upstream node and a second total-power input at the downstream node with one or more Raman pump lasers on; and
determining a measured Raman gain for the optical span by comparing (a) a difference between the first total-power output and the first total-power input to (b) a difference between the second total-power output and the second total-power input.

2. The method of claim 1, wherein the baseline measurement was determined when one or more Raman pump lasers associated with the optical span were turned off.

3. The method of claim 1, wherein the measured Raman gain reflects an effective gain achieved over all of the optical span rather than only at a local amplifier input.

4. The method of claim 1, wherein the steps further include
updating the measured Raman gain in-service whenever at least one of a target Raman gain is adjusted, a spectral loading changes, or a total launch power varies in the upstream node.

5. The method of claim 4, wherein the target Raman gain is automatically re-optimized by a control system in response to measured fiber losses or channel loading changes, and the step of updating the measured Raman gain occurs in near real-time without requiring an external manual recalibration request.

6. The method of claim 1, wherein the Raman pump lasers operate in a counter-propagation mode, a co-propagation mode, or a hybrid bidirectional mode, and wherein the step of determining the measured Raman gain is performed in a manner agnostic to propagation direction.

7. The method of claim 1, wherein a baseline span loss is determined by subtracting the first total-power output from the first total-power input in dB, and an updated span loss is determined by subtracting the second total-power output from the second total-power input in dB, the measured Raman gain being the difference between the two span losses.

8. The method of claim 1, wherein the steps further include detecting and compensating for Raman gain compression, decompression, or
suppression in the optical span by recalculating the measured Raman gain each time a significant reduction or increase in total launch power is detected at the upstream node.

9. The method of claim 1, wherein the steps further include coordinating the measured Raman gain with an erbium-doped fiber amplifier (EDFA) upstream or downstream of the optical span, such that changes in EDFA output power trigger corresponding updates in the step of computing the Raman gain to maintain accurate span loss calculations.

10. The method of claim 1, wherein both the upstream node and the downstream node:
a) store the baseline measurement locally when the one or more Raman pump lasers are turned off; and
b) exchange the stored baseline measurement once optical supervisory channel (OSC) communication is re-established, thereby synchronizing baseline data used to determine the measured Raman gain.

11. A non-transitory computer-readable medium storing instructions for measuring Raman gain in an optical span, the instructions, when executed, cause one or more processors to perform steps of:
subsequent to determining a baseline measurement of a first total-power output at an upstream node and a first total-power input at a downstream node, causing a measurement a second total-power output at the upstream node and a second total-power input at the downstream node with one or more Raman pump lasers on; and
determining a measured Raman gain for the optical span by comparing (a) a difference between the first total-power output and the first total-power input to (b) a difference between the second total-power output and the second total-power input.

12. The non-transitory computer-readable medium of claim 11, wherein the baseline measurement was determined when one or more Raman pump lasers associated with the optical span were turned off.

13. The non-transitory computer-readable medium of claim 11, wherein the measured Raman gain reflects an effective gain achieved over all of the optical span rather than only at a local amplifier input.

14. The non-transitory computer-readable medium of claim 11, wherein the steps further include
updating the measured Raman gain in-service whenever at least one of a target Raman gain is adjusted, a spectral loading changes, or a total launch power varies in the upstream node.

15. The non-transitory computer-readable medium of claim 11, wherein the Raman pump lasers operate in a counter-propagation mode, a co-propagation mode, or a hybrid bidirectional mode, and wherein the measured Raman gain is determined in a manner agnostic to propagation direction.

16. The non-transitory computer-readable medium of claim 11, wherein a baseline span loss is determined by subtracting the first total-power output from the first total-power input in dB, and an updated span loss is determined by subtracting the second total-power output from the second total-power input in dB, the measured Raman gain being the difference between the two span losses.

17. The non-transitory computer-readable medium of claim 11, wherein the steps further include
detecting and compensating for Raman gain compression, decompression, or suppression in the optical span by recalculating the step of computing the Raman gain each time a significant reduction or increase in total launch power is detected at the upstream node.

18. An apparatus comprising circuitry configured to:
obtain a baseline measurement of total power under a first set of conditions,
obtain an updated measurement of total power under a second set of conditions in which one or more Raman pumps are activated, the total power under each of the first and second set of conditions is associated with an optical span, and
determine a measured Raman gain based on the updated measurement and the baseline measurement.

19. The apparatus of claim 18, wherein the baseline measurement is determined while the one or more Raman pumps associated with the optical span are deactivated.

20. The apparatus of claim 18, wherein the measured Raman gain characterizes overall gain across the optical span, without limiting the measurement to a specific localized amplifier input.
